(19) United States
(12) Patent Application Publication
(10) Pub. No.: US 2026/0186500 A1
(43) Pub. Date: Jul. 2, 2026

(54) ARTIFICIAL INTELLIGENCE DRIVEN SATELLITE REMOTE SENSING DETECTION AND TRACKING OF SAND MOVEMENT

(71) Applicant: Saudi Arabian Oil Company, Dhahran (SA)

(72) Inventors: Ahmed Aljarro, Thuwal (SA); Frankly Leonardo Toro Gonzalez, Thuwal (SA); Ali Al Shehri, Thuwal (SA); Mohmmed T. Abdulmohsin, Dhahran (SA)

(21) Appl. No.: 19/008,096

(22) Filed: Jan. 2, 2025

(51) Int. Cl. G05D 1/648; G05D 105/10; G05D 111/10; G06V 10/24; G06V 10/25; G06V 10/82; G06V 20/13

(52) U.S. Cl. CPC G05D 1/648; G06V 10/24; G06V 10/25; G06V 10/82; G06V 20/13; G05D 2105/10; G05D 2111/10; G06V 2201/10

(57) ABSTRACT

Systems and methods include receiving data corresponding to a region of interest, monitored for sand movement. The data includes remote sensing images of the region of interest captured at a plurality of time points and respective metadata. A first artificial intelligence model processes the remote sensing images and the respective metadata, to determine a sand distribution change within the region of interest. A second artificial intelligence model is used to classify, the sand distribution change into multiple sand movement formations. Sand movement patterns are determined based on the plurality of sand movement formations; and identifying an action plan to remedy an effect of the sand movement patterns.

### TECHNICAL FIELD

The present disclosure is generally related to material detection based on remote sensing images and, more specifically, to computer-implemented methods, software, and systems for automatic detection of sand movement patterns.

### BACKGROUND

Remote sensing images include information about materials, such as sand, distributed within a scanned area. The resolution and quality of images can limit the identification of sand distribution and movement patterns within a scanned area. For example, low-resolution images are limited in capturing the subtle changes in sand patterns. The detection of sand distribution and movement patterns can also be affected by environmental factors. For example, wind speed, wind direction, vegetation, and topography can significantly impact the sand movement including non-linear temporal changes. The temporal variations in sand movement can include rapid and irregular changes, such that low frequency image capture can generate data collection gaps that affect the detection results. The impact of environmental factors on sand distribution can make detection of sand movement patterns more complex. The sand movement pattern complexity can be accentuated by processing large volumes of remote sensing imagery data that use significant computational resources to analyze and interpret the sand movement patterns.

### SUMMARY

Implementations of the present disclosure are directed to material detection based on remote sensing images. More particularly, implementations of the present disclosure are directed to computer-implemented methods, software, and systems for automatic detection of sand movement patterns.

In some implementations, a computer-implemented method includes: receiving data corresponding to a region of interest, the data including remote sensing images of the region of interest captured at a plurality of time points and respective metadata, determining by processing the remote sensing images and the respective metadata, using a first artificial intelligence model, a sand distribution change within the region of interest, classifying, using a second artificial intelligence model, the sand distribution change into a plurality of sand movement formations, determining sand movement patterns based on the plurality of sand movement formations, and identifying an action plan to remedy an effect of the sand movement patterns.

The foregoing and other implementations can each optionally include one or more of the following features, alone or in combination. In particular, implementations can include all the following features:

In a first aspect, combinable with any of the previous aspects, wherein the computer-implemented method includes preprocessing the remote sensing images by applying geometric alignments to the remote sensing images to generate aligned images and applying radiometric corrections to the aligned images to generate corrected images. In other aspects, identifying the action plan includes determining a risk associated with the sand movement patterns, and generating an alert indicative of the risk associated with the sand movement patterns. The remote sensing images can include satellite images. The sand movement patterns can include constant flows, seasonal changes, and wind generated patterns. The effect of the sand movement patterns can be determined relative to one or more points of interests. Identifying the action plan to remedy the effect of the sand movement patterns can include activating an equipment to clean or protect the one or more points of interests.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

Implementations described in the present disclosure, provide an accurate identification and masking of pixels corresponding to sand distribution, facilitating the application of clustering algorithms to pure pixels that represent distinct and homogenous material features. The described approach efficiently removes the noise associated with pixels that do not correspond to sand accumulation, providing the advantage of significantly improving the separation of clusters in the feature space, resulting in more precise and stable cluster formation. The cluster formation improvement of the described implementations is particularly significant for density-seeking hierarchical clustering algorithms, such as single-link clustering, which are sensitive to noise, especially in the region between clusters. Another advantage of the described technology is that it ensures that only high-quality, pixels including signals corresponding to sand are considered at all scales in the image, the segmentation process becoming more robust, producing clearer and more meaningful segmentations that better represent the range of materials in the image. The described technology substantially improves over existing methods in that it retains spectra representing pure materials that lie close to the boundaries of the pure clusters. The described technology provides a valuable tool for accurate optical, synthetic aperture radar (SAR), interferometric SAR (InSAR), infrared (IR), and/or multi/hyperspectral image analysis and interpretation with respective myriad applications. Another advantage of the described technology is that the described mapping of materials can trigger automatic operations for systems and machines configured to maintain environmental safety and system operability.

The details of one or more implementations of the subject matter of the specification are set forth in the accompanying drawings and the description below. Other features, aspects, and advantages of the subject matter can become apparent from the description, the drawings, and the claims.

### DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A is a block diagram of an example system that can be used to execute implementations of the present disclosure.

FIG. 1B is a block diagram of a portion of the example system that can be used to execute implementations of the present disclosure.

FIG. 2A illustrates an example of a remote sensing image acquired at a first time point, according to some implementations of the present disclosure.

FIG. 2B illustrates an example of a remote sensing image acquired at a second time point, according to some implementations of the present disclosure.

FIG. 2C illustrates an example output data including detected sand distribution and movement patterns, according to some implementations of the present disclosure.

FIG. 3 is a flowchart illustrating an example process for sand movement patterns, in accordance with some example embodiments.

FIG. 4 depicts a block diagram illustrating a computing system, in accordance with some example embodiments.

When practical, like labels are used to refer to same or similar items in the drawings.

### DETAILED DESCRIPTION

The following detailed description describes techniques for material detection based on remote sensing images. More particularly, implementations of the present disclosure are directed to computer-implemented methods, software, and systems for automatic detection of sand movement patterns. The described implementations provide identification of a sand distribution change within the region of interest, by processing remote sensing images and respective metadata, using identification, detection, and/or a first classification model. The remote sensing images can include satellite images and/or drone collected images of an aera of interest at multiple points in time. The change of the sand distribution within the region of interest can be induced by multiple factors, including environmental conditions. The change of the sand distribution within the region of interest can be classified, using a second classification model, into formations that are used to determine sand movement patterns. The map of sand movement patterns facilitates automatic action initiation.

Some traditional detection algorithms of sand movement patterns include satellite remote sensing. Satellite images can be collected from various technology service providers. The satellite images can be collected at a set frequency, facilitating regular monitoring of an area of interest. In some implementations, remote sensing methods includes calculating pixel displacement for the interpretation of features. The sand distribution methods can include detection of variations in spectral reflectance of pixels of images, aiming to identify features of interest. Sand includes of a mixture of sand grains with varying mineral composition and size, resulting in different spectral signatures generating difficulties in the identification of sand distribution and movement.

Addressing the limitations of traditional detection algorithms of sand movement patterns, the techniques of the present disclosure effectively identify subtle sand distribution changes and movement patterns using modern artificial intelligence analytics. An advantage of the described implementations is that they facilitate unsupervised processing of remote sensing images leading to accurate sand distribution mapping and automatic introduction of remedial measures. The remote sensing image processing described in the present disclosure significantly improves the analysis of images acquired by satellites orbiting the Earth for sand distribution change detection. The sand distribution change detection is classified based on different formations to identify and locate particular change detections with patterns attributed to sand movement. The pattern detection is selected based on series of images corresponding to shorter or longer periods of time intervals. The described approach provides an improvement of accuracy of sand distribution changes and movement patterns, using a robust automatic algorithm.

The techniques described in the present disclosure provide a solution addressing the problems associated to environmental monitoring being less intrusive and having a lower environmental impact compared to ground-based methods, preserving the natural state of the surveyed areas. Such environmental monitoring and rapid detection and tracking of sand distribution changes facilitate initiation of operations that protect one or more objectives of interest, such as continuous access to roads and industrial facilities. Other applications of the described approach include exploration and discovery of sand distribution changes and movement patterns for surveying techniques, such as geology mapping, and landscape transformation detection.

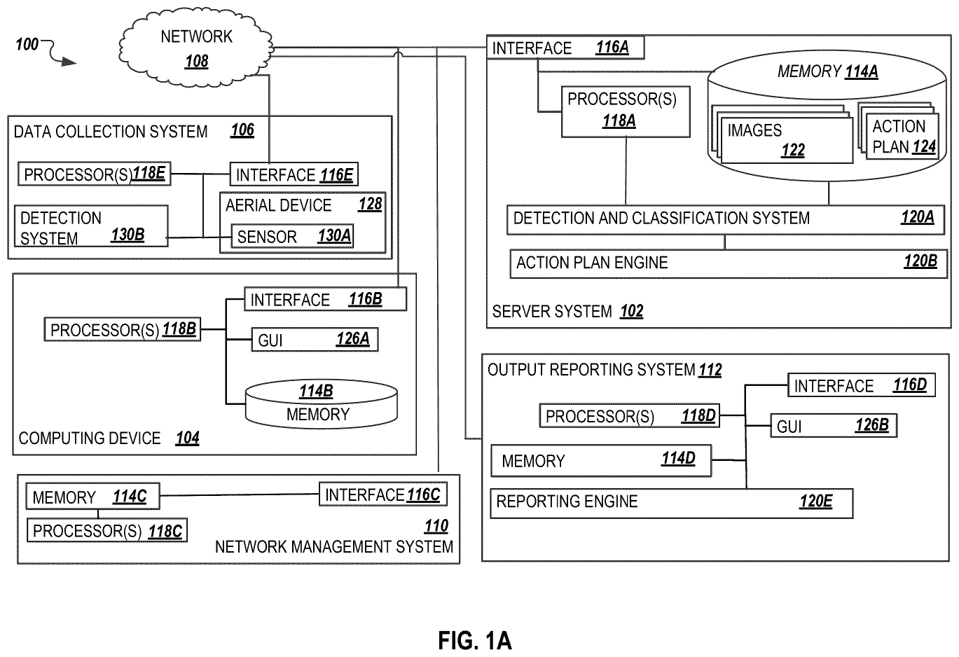

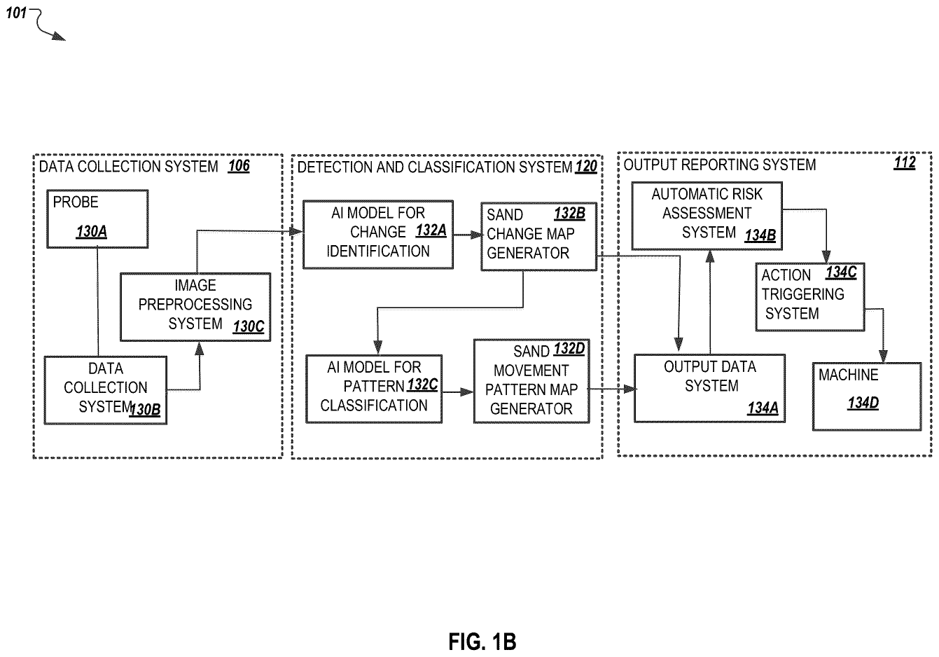

FIG. 1A is a block diagram illustrating an example system 100 that can be used to execute implementations of the present disclosure. For example, example system 100 can be configured to execute sand movement pattern detection algorithms based on remote sensing image processing. The illustrated example system 100 includes or is communicably coupled with a server system 102, a computing device 104, a data collection system 106, a network 108, a network management system 110, and an output reporting system 112. Although shown separately, in some implementations, functionality of two or more systems or components of the example system 100 may be provided by a single system or server. In some implementations, the functionality of one illustrated system, server, or component may be provided by multiple systems, servers, or components, respectively.

In the example of FIG. 1A, the server system 102 is intended to represent various forms of servers including, but not limited to a web server, an application server, a proxy server, a network server, and/or a server pool. In general, the server system 102 manages sand movement pattern detection algorithms from remote sensing image processing. In accordance with implementations of the present disclosure, and as noted above, the server system 102 can host a solution environment that can be a cloud environment providing software applications, systems, and services that can be consumed by customers as a service. In some instances, the server system 102 can support configuring of various tenants of different types, as well as services of different types that are integrated in customer integration scenarios and support execution of defined processes.

For example, the server system 102 includes a memory 114A, an interface 116A, a processor 118A, and a detection and classification system 120 and an action plan engine 120B. The memory 114A can include remote sensing images 122 and action plans 124. The remote sensing images 122 include images collected by and received from the data collection system 106. The remote sensing images 122 can include images detected by remote sensors attached to aerial devices 128 (e.g., satellites and/or drones). The remote sensing images 122 can be processed by the detection and classification system 120A to generate sand distribution and pattern movement maps that are processed by the action plan engine 120B to generate action plans 124. The action plans 124 in the memory 114A can include action plan documents defining remedial operations performed by systems and machine for management and redistribution of materials including sand.

The computing device 104, the network management system 110, and the output reporting system 112 may each be any computing device operable to connect to or communicate in the network(s) 108 using a wireline or wireless connection. In general, each of the computing device 104, the network management system 110, and the output reporting system 112 includes an electronic computer device operable to receive, transmit, process, and store any appropriate data associated with the example system 100 of FIG. 1A. Each of the computing device 104, the network management system 110, and the output reporting system 112 is generally intended to encompass any client computing device such as a laptop/notebook computer, wireless data port, smart phone, personal data assistant (PDA), tablet computing device, one or more processors within these devices, or any other suitable processing device. The computing device 104, the network management system 110, and the output reporting system 112, respectively include interface(s) 116B, 116C, 116D, processor(s) 118B, 118C, 118D, and memories 114B, 114C, 114D.

The computing device 104 and the output reporting system 112, respectively include graphical user interface(s) (GUIs) 126A and 126B. For example, the GUIs 126A, 126B include an input device, such as a keypad, touch screen, or other device that can accept user information, and an output device that conveys information associated with the operation of the server system 102, or the client device itself, including a display of the material maps and action plan operations selected based on the material movement patterns. The GUIs 126A, 126B each interface with at least a portion of the example system 100 for any suitable purpose, including generating a visual representation of the remote sensing images 122 collected by the data collection system 106, the material maps generated by the server system 102, or data stored by the server system 102, such as remote sensing images 122 and action plans 124, respectively. In particular, the GUIs 126A, 126B may each be used to view and adjust various action plans 124. Generally, the GUIs 126A, 126B each provide the user with an efficient and user-friendly presentation of the material maps (e.g., sand distribution and sand pattern change maps) as images and action plans 124 including recommended sand movement operations communicated within the example system 100. The GUIs 126A, 126B may each include multiple customizable frames or views having interactive fields, for selection of regions of interest and/or display of material maps for different regions and time points. The GUIs 126A, 126B can each be any suitable graphical user interface, such as a combination of a generic web browser, intelligent engine, and command line interface (CLI) that processes information and efficiently presents the results to the user visually.

The output reporting system 112 can include a reporting engine 120C, the GUI 126B (dashboard), an interface 116D, and a processor 118D. The reporting engine 120C utilizes the analytics data provided by the action plan engine 120B to produce executive and semi executive level displays for the GUI 126B. The GUI 126B displays a high-level summary of a material map assessment, which provides support for material movement patterns in addition to key recommended actions for environment and plant safety. The GUI 126B display can facilitate material management and decision makers to modify (operations of) the systems and machines selected for cleaning identified materials.

The data collection system 106 can include multiple imaging sensors 130A and a detection system 130B. The imaging sensors 130A can be within a remote sensing device 128 (e.g., attached to or included in the remote sensing device), acquiring samples and data during a flight or a hovering operation. The imaging sensors 130A and the detection system 130B can include any of a hyperspectral sensor, spectroradiometers (e.g., ultraviolet/visible/near infrared/short wave infrared spectroradiometers), a camera, and other types of probes. The processor 118E of the data collection system 106 controls operation of the imaging sensors 130A and the detection system 130B and directs collected and determined data to the server system 102 for storage, further analysis, and modelling. The imaging sensors 130A and the detection system 130B can collect remote sensing images of one or more areas of interest below the remote sensing device 128, such as multispectral images. Further details about the imaging sensors 130A and the detection system 130B and their operation are provided with reference to FIG. 1B.

In some implementations, the network 108 can include a large computer network, such as a local area network, a wide area network, the Internet, a cellular network, a telephone network, or any appropriate combination thereof connecting any number of communication devices, mobile computing devices, fixed computing devices and server systems. Data exchanged over the network 108, is transferred using any number of network layer protocols, such as Internet Protocol, Multiprotocol Label Switching, Asynchronous Transfer Mode, Frame Relay, etc. Furthermore, in implementations where the network 108 represents a combination of multiple sub-networks, different network layer protocols are used at each of the underlying sub-networks. In some implementations, the network 108 represents one or more interconnected internetworks, such as the public Internet.

Each processor 118A, 118B, 118C, 118D, 118E included in different components of the example system 100 can include a central processing unit, an application particular integrated circuit, a field-programmable gate array, or another suitable component. Generally, each processor 118A, 118B, 118C, 118D, 118E executes instructions and manipulates data for sand movement patterns. Each processor 118A, 118B, 118C, 118D, 118E executes a functionality required to monitor remote sensing images associated to an aerial device 128, to monitor and correct material movement patterns.

Interfaces 116A, 116B, 116C, 116D, 116E are used by different components of the example system 100 for communicating with other component systems in a distributed environment—including within the example system 100—connected to the network 108. Generally, the interfaces 116A, 116B, 116C, 116D, 116E each include logic encoded in software and/or hardware in a suitable combination and operable to communicate with the network 108. More specifically, the interfaces 116A, 116B, 116C, 116D, 116E may each include software supporting one or more communication protocols associated with communications such that the network 108 or interface's hardware is operable to communicate physical signals within and outside of the illustrated system 100.

The memory 1114A, 114B, 114C, 114D may include any type of memory or database module and may take the form of volatile and/or non-volatile memory including, without limitation, magnetic media, optical media, random access memory, read-only memory, removable media, or any other suitable local or remote memory component. The memory 1114A, 114B, 114C, 114D may store various objects or data, including caches, classes, frameworks, applications, backup data, business objects, jobs, web pages, web page templates, database tables, database queries, repositories storing images 122 (e.g., remote sensing images and/or dynamic information, and any other appropriate information including material movement pattern models, and any material cleaning parameters, variables, algorithms, instructions, rules, constraints, or references thereto) associated with the purposes of the server system 102, the computing device 104, the data collection system 106, the network management system 110, and the output reporting system 112, respectively.

There may be any number of computing devices 104 and data collection systems 106 associated with, or external to, the example system 100. Additionally, there may also be one or more additional client devices external to the illustrated portion of system 100 that are configured for interacting with the example system 100 via the network(s) 108. Further, the term “client,” “client device,” and “user” may be used interchangeably as appropriate without departing from the scope of the disclosure. Moreover, while client device may be described in terms of being used by a single user, the disclosure contemplates that many users may use one computer, or that one user may use multiple computers. As used in the present disclosure, the term “computer” is intended to encompass any suitable processing device. For example, although FIG. 1A illustrates a single server system 102, a single computing device 104, a single data collection system 106, a single network management system 110, the example system 100 can be implemented using a single, stand-alone computing device, two or more core systems 102, or multiple client devices. The server system 102, the computing device 104 and the output reporting system 112 may include any computer or processing device such as, for example, a blade server, general-purpose personal computer, workstation, or any other suitable device. In other words, the present disclosure contemplates computers other than general purpose computers, as well as computers without conventional operating systems. Further, the server system 102 and the computing device 104 and the output reporting system 112 may be adapted to execute any operating system or runtime environment. According to one implementation, the server system 102 may also include or be communicably coupled with an e-mail server, a Web server, a caching server, a streaming data server, and/or another suitable server, as described with reference to FIG. 1B.

FIG. 1B is a block diagram of a portion of the example system 100 that can be used to execute implementations of the present disclosure. In particular, FIG. 1B depicts a schematic diagram illustrating an example portion 101 of a variation of the example system 100 described with reference to FIG. 1A, in accordance with some example embodiments. The example portion 101 of the example system 100 illustrated in FIG. 1B includes the data collection system 106, a detection and classification system 120A, and an output reporting system 112.

The data collection system 106 includes imaging sensors 130A, a data collection system 130B, and an image preprocessing system 130C. The imaging sensors 130A can be coupled to the remote sensing device 128 and can be displaced to capture remote sensing images of multiple regions of interest. The imaging sensors 130A and the detection system 130B are communicatively connected to the processor 118E. The imaging sensors 130A can include red, green, blue (RGB) imaging devices, aerial sensors, and hyperspectral sensors (e.g., infrared imaging spectrometers), or other imaging systems facilitating the collection of remote sensing images. The data collection system 130B can generate triggers according to a particular schedule to control data collection executed by the imaging sensors 130A. The data collection system 130B can receive the remote sensing images collected by the imaging sensors 130A and transmit them to the image preprocessing system 130C for pre-processing.

The image preprocessing system 130C executes pre-processing of remote sensing images that can enhance data quality and can ensure accurate downstream analysis. The image preprocessing can include applying geometric alignments to the remote sensing images to generate aligned images and applying radiometric corrections to the aligned images to generate corrected images. geometric alignments and radiometric corrections. The image preprocessing can include: noise correction to remove sensor noise using correction coefficients during image processing; vignetting correction to address uneven illumination across the image caused by lens vignetting; lens distortion correction to apply distortion models to correct lens-induced distortions; band registration to align spectral bands to ensure consistent spatial information; and radiometric correction to normalize pixel values to account for variations in sensor sensitivity. For aerial sensors attached to unmanned aerial vehicles, the pre-processing steps optimize data quality, enabling accurate sand distribution monitoring and other applications.

The detection and classification system 120A includes an artificial intelligence (AI) model for sand change identification 132A, a sand change map generator 132B, an AI model for sand movement pattern classification 132C, and a sand movement pattern map generator 132D. The AI model for sand change identification 132A includes a machine learning model that is based on machine learning techniques including neural networks (e.g., deep neural network (DNN)) and random forests. Machine learning models can identify sand accumulation in various soil environments, such as within or nearby industrial facilities including oilfields. The AI model for sand change identification 132A can classify sand particles based on the detected size and shape. For example, images of sand particles captured using dynamic image analysis can be analyzed using machine learning algorithms to classify them with high accuracy. In an example, a DNN of the subject technology can generate dynamically adjusted sand change estimates. The DNN model can represent the relationship between remote sensing images collected by the data collection system 106 at multiple time points and the changes in sand distribution within a region of interest. In one or more implementations, relationships the images collected by the data collection system 106, and metadata can be determined during training of the DNN. The training step optimizes the weights and biases in a hidden and an output layer of the DNN such that the estimation error between the estimated changes in sand distribution within a region of interest and observed changes in sand distribution (e.g., confirmed using terrain measurements) can be minimized. Estimation error can be root mean square deviation, or a composite of root mean square deviation, cross-correlation, or a geoscience error metric. To avoid overfitting during training, regularization of the estimation error is performed based upon the norms of weights in the hidden layers that are added to the estimation error. An optimization process can include application of a stochastic gradient descent algorithm (or any other appropriate optimization algorithm), which can use one or more iterative optimization techniques and/or use a small subset of the training dataset or batch with training samples randomly selected at a time. The variances calculated based upon the horizontal and vertical semi-variograms are included in the input feature. The optimization process can optimize the weights and biases associated with the vertical and horizontal semi-variances, and other input features such that an error in the property estimates relative to the observed sand distribution values can be minimized. The process of training described here not only can minimize the error in sand distribution estimates, but also can incorporate sand amount variance relative to one or more reference points (e.g., road mapping and/or industrial facilities). Following the completion of training that can be determined by the estimation error on the validation dataset falling below a cut-off value, the remote sensing images and corresponding metadata can be used to determine the performance of the trained DNN on unseen remote sensing images (e.g., not used for training). The trained DNN provides the ability of identifying the sand changes based on the estimated sand amount. Although a DNN was discussed for the purposes of explanation, it is appreciated that the AI model for sand change identification 132A can include other trainable machine learning techniques. Further, it is appreciated that other types of neural networks can be utilized by the subject technology. For example, a convolutional neural network, regulatory feedback network, radial basis function network, recurrent neural network, modular neural network, instantaneously trained neural network, spiking neural network, regulatory feedback network, dynamic neural network, neuro-fuzzy network, compositional pattern-producing network, memory network, and/or any other appropriate type of neural network can be utilized. In some implementations, the detection and classification system 120A includes transformer-based architectures. The transformer-based architectures can use a Siamese vision transformer (SViT) to establish global semantic relations and model long-range context. SViT is configured to handle noisy changes induced by environmental variations, making it robust for detecting significant changes in sand distribution. The transformer-based architectures can use a Scratch Former model that is configured for remote sensing change detection. The transformer-based architectures can use a shuffled sparse attention mechanism to focus on sparse informative regions, which is crucial for detecting changes in sand distribution. The transformer-based architectures can incorporate a change-enhanced feature fusion module to improve the detection of relevant sand changes while reducing noise. The transformer-based architectures can use a change former architecture that combines a hierarchically structured transformer encoder with a multi-layer perceptron (MLP) decoder in a Siamese network. The change former architecture captures multi-scale long-range details, which provide accurate change detection in sand distribution. The transformer-based architectures can use dual cross-attention transformer model that uses a hybrid dual-branch mixer that combines convolution and transformer techniques to extract and fuse local and global features of sand distribution changes. The dual cross-attention transformer model calculates cross-attention features to learn comprehensive cues from paired images, making it effective for sand change detection. The transformer-based models offer advanced capabilities for accurately detecting and monitoring changes in sand distribution, leveraging long-range dependencies and handle noisy data effectively.

The sand change map generator 132B can include a system configured to format the outcome of the AI model for sand change identification 132A in a displayable format. For example, a multidimensional matrix generated by the AI model for sand change identification 132A can be converted by the sand change map generator 132B into an image. The sand change map generator 132B can include one or more reference points within the image to enable a visualization of the sand change within the region of interest relative to the reference points. The sand change map generator 132B can transmit the generated images of the sand change to the output reporting system 112. The sand change map generator 132B can include a masking engine to apply a filter mask to enhance the sand change map.

The AI model for sand movement pattern classification 132C can classify sand movement patterns into multiple formations. The AI model for sand movement pattern classification 132C includes a machine learning model that is based on machine learning techniques including neural networks (e.g., DNN) and clustering algorithms. The machine learning techniques can be trained to classify sand movement patterns using labeled sand movement patterns. In some implementations, clustering algorithms for sand movement pattern classification include K-means clustering algorithm partitions data into (k) clusters by minimizing the sum of squared distances between data points and the respective cluster centroids. The K-means clustering algorithm can use as an input a predefined number of clusters. In some implementations, clustering algorithms for sand movement pattern classification include hierarchical clustering that builds a hierarchy of clusters by either merging smaller clusters into larger ones (agglomerative) or splitting larger clusters into smaller ones (divisive), providing information about the data structure at different levels of granularity. In some implementations, clustering algorithms for sand movement pattern classification include density-based clustering (DBSCAN) that groups together points that are closely packed together, marking points that are in low-density regions as outliers. DBSCAN can be particularly effective for datasets with noise and varying densities. In some implementations, clustering algorithms for sand movement pattern classification include spectral clustering that uses the eigenvalues of a similarity matrix to reduce dimensionality before clustering in fewer dimensions. The spectral clustering can be applied to complex data structures that are not well-separated in the original space. In some implementations, clustering algorithms for sand movement pattern classification include density peak clustering (DPC) to identify cluster centers as points with higher local density than their neighbors and are far from each other. The DPC model can be effective for identifying clusters of varying shapes and densities. The clustering algorithms can help in analyzing and classifying sand movement patterns by identifying distinct clusters of movement based on various features such as velocity, direction, and frequency of movement.

The AI model classification system 132C can process multiple maps of materials of a particular region, corresponding to multiple time points to generate material variation patterns. The AI model classification system 132C can include machine learning techniques (e.g., neural networks) trained to analyze spatial sand distribution data (e.g., maps) and reveal patterns over time. The sand movement pattern map generator 132D can include a system configured to format the outcome of the AI model for sand movement pattern classification 132C in a displayable format. For example, a multidimensional matrix generated by the AI model for sand movement pattern classification 132C can be converted by the by the sand movement pattern map generator 132D into an image. The sand movement pattern map generator 132D can include one or more reference points within the image to enable a visualization of the sand patterns within the region of interest relative to the reference points. The sand movement pattern map generator 132D can transmit the generated images of the sand change to the output reporting system 112. The sand movement pattern map generator 132D can include a masking engine to apply a filter mask to enhance the sand movement pattern map.

The output reporting system 112 includes an automatic risk assessment system 134A, an output data system 134B, an action triggering system 134C, and a machine 134D. The automatic risk assessment system 134A can process the sand variation patterns and most recently generated maps of sand distribution to determine risks associated to one or more points of interests (e.g., roads, industrial plants, oil drilling and processing systems, etc.). The output data system 134B can include a GUI (e.g., GUI 126 described with reference to FIG. 1A) to generate displays indicating the identified risk. The action triggering system 134C can receive the determined risk, classify the risk (e.g., low, medium, or high) and, based on the classification, generate a trigger to send to the machine 134D to perform a remedial action (e.g., cleaning or relocation of material within the region of interest to protect the one or more points of reference).

While portions of the example system 100 illustrated in FIGS. 1A and 1B are shown as individual modules that implement the various features and functionality through various objects, methods, or other processes, the hardware components can execute software that can include multiple sub-modules, third-party services, components, libraries, and such, as appropriate. Conversely, the features and functionality of various components can be combined into single components as appropriate.

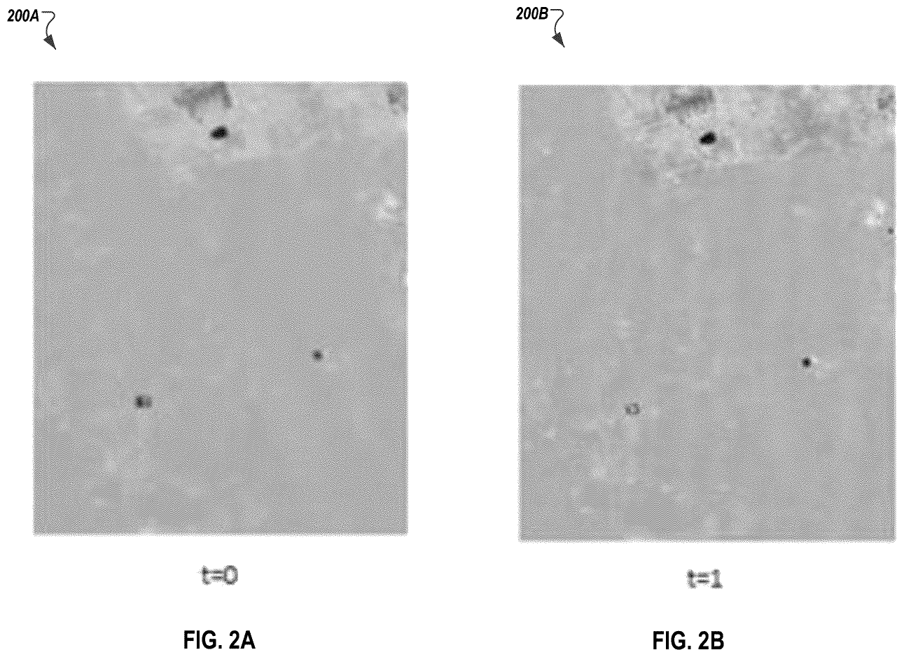

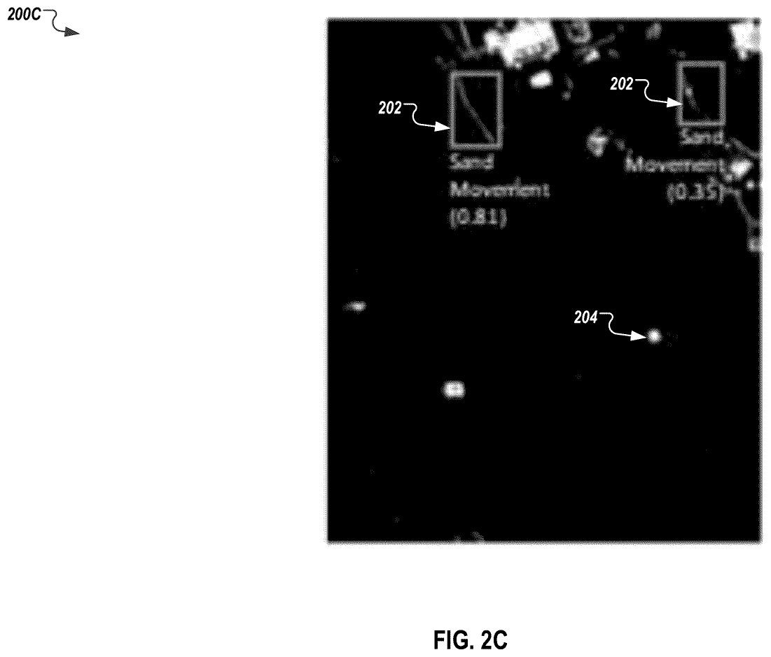

FIG. 2A illustrates an example of a remote sensing image 200A acquired at a first time point, according to some implementations of the present disclosure. The example remote sensing image 200A includes a multi-or hyperspectral image. The example remote sensing image 200A can include hyperspectral imagery to provide detailed spectral information, facilitating identification of sand and respective unique signatures. The example remote sensing image 200A can have N=W*H pixels (with width W and height H), with each pixel having an associated spectrum consisting of C “channels” (or “bands”, or “dimensions”). For example, example remote sensing image 200A can include 1,262×1,533=1,934,646 pixels with 12 bands. The example of a multi-or hyperspectral image 200A can be captured by aerial sensors that generate data in a few wavelength bands (e.g., 3 to 10 bands), such as red, green, blue, near infrared, and short-wave infrared. The bands can have descriptive titles and a spatial resolution of 30 meters (except for a few particular bands). The example remote sensing image 200A can help identify sand encroachment at a first time point.

FIG. 2B illustrates an example of a remote sensing image 200B acquired at a second time point, according to some implementations of the present disclosure. The example remote sensing image 200B can be captured by the same or similar aerial sensors that generate the example remote sensing image 200A detected at a first time point. For example, the example remote sensing image 200B includes a same image type as the example remote sensing image 200A detected at a first time point (e.g., multi-or hyperspectral image). The example remote sensing image 200B can have a same number of pixels as the example remote sensing image 200A acquired at a first time point N=W*H pixels (with width W and height H), with each pixel having an associated spectrum consisting of C “channels” (or “bands”, or “dimensions”). For example, the example remote sensing image 200B can include (e.g., 1,262×1,533=1,934,646 pixels with 12 bands). The example remote sensing image 200B can help identify sand encroachment at a second time point.

FIG. 2C illustrates an example output data 200C including detected sand distribution and movement patterns, according to some implementations of the present disclosure. The example output data 200C can include a grayscale representation of the variability of the sand movement change around each pixel within a time interval (e.g., between the first and second time point). The example output data 200C represents magnitude of sand amount changes around each pixel using shades of gray, ranging from 0 (black) to 255 (white). The grayscale representation of spectral variability of the example output data 200C illustrates local sand distribution variations, sand movement boundaries, and sand movement patterns. Local variations of the example output data 200C can include darker areas that indicate regions with low sand amounts and minimal sand amount changes. Brighter areas of the example output data 200C correspond to regions with high variability, where neighboring pixels exhibit significant differences in the sand distribution variations. The boundaries of the movement patterns within the example output data 200C can be defined by sand distribution boundaries and/or transitions. For example, the boundary between areas with high and low sand amounts may appear as a distinct edge in the grayscale representation. Texture and patterns of the example output data 200C can include fine-scale texture and patterns within an image that become visible. The appearance of the example output data 200C depends on the type of input data (e.g., hyperspectral data), the time difference between the collected input data, and the context of the input data, as described with reference to FIGS. 2A and 2B. The example output data 200C can include highlights 202 (e.g., frames or circular markers) around identified sand movements and markers 204 indicative of locations of points of interest within the area of interest.

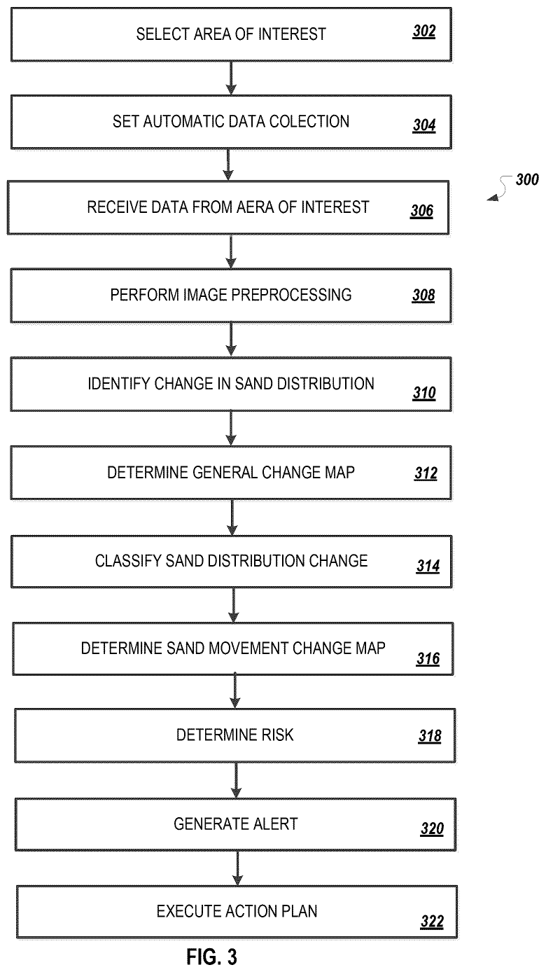

FIG. 3 depicts a flowchart illustrating an example process 300 for sand movement pattern detection algorithms, in accordance with some example embodiments. Referring to FIGS. 1A and 1B, the example process 300 can be performed by any components of the example systems 100 and 101.

At 302, an area (region) of interest is selected, by one or more processors. The area of interest can be selected by setting the area of interest by either setting a bounding box in the map or by defining top left and bottom right coordinates. The area of interest can be selected based on a monitoring plan of one or more points of interest. The points of interest can include industrial plants, industrial equipment, access points (roads, helipads, launching pads) to industrial plants and/or industrial equipment. The area of interest can be selected based on one or more plans to access the industrial plants and/or the industrial equipment.

At 304, an automatic data collection schedule is set and implemented, by the one or more processors. The automatic data collection schedule can define multiple time points to collect remote sensing images of an area of interest. The automatic data collection schedule can define remote sensing image collection within short-time intervals or long-time intervals. In some implementations, the automatic data collection schedule can define a normal operational mode of low data collection frequency and an event associated operational mode of high data collection frequency. The sensors collecting data including remote sensing images can be set to operate in the normal operational mode and switch to the event associated operational mode in response to receiving an indicator of an upcoming or ongoing event (e.g., weather event, such as storm).

At 306, data is received, by the one or more processors, from a region of interest. The data includes remote sensing images and metadata. The remote sensing image can be received from a satellite, or an aerial device (e.g., aerial device 128 described with reference to FIG. 1A) equipped with a remote sensing image acquisition device. A typical multi-or hyperspectral image (e.g., example remote sensing image 200A) can have N=W*H pixels (with width W and height H), with each pixel having an associated spectrum consisting of C “channels” (or “bands”, or “dimensions”). The set of spectra associated with the pixels can be represented as vectors in a multi-dimensional (e.g., 12-dimensional) space, where sand (and other materials) with similar spectra can form clusters of high density. The remote sensing image can be processed to obtain one or two-dimensional cross sections showing the first two principal components of the 12-dimensional spectral vector space. Every point in the scatterplot can corresponds to the spectrum of a vector associated with a pixel in the original remote sensing image. The set of spectra associated with the pixels can be represented as a scatterplot including vectors in a 12-dimensional space, where materials with similar spectra can form clusters of high density. Every point in the scatterplot corresponds to the spectrum of a vector associated with a pixel in the original image. The metadata can provide information about the collected remote sensing images. The metadata can include geospatial information, such as coordinates: latitude and longitude of the image corners or center and projection information, such as details about the map projection used, such as the geodetic datum and coordinate system. The metadata can include temporal information, such as acquisition date and time defining when the image was captured, often including the exact timestamp. The metadata can include sensor information, such as sensor type indicating the type of sensor used (e.g., optical, radar) and sensor angles, such as angles at which the sensor captured the image, including azimuth and elevation angles. The metadata can include radiometric information, such as resolution including spatial resolution (e.g., 10 meters per pixel) and spectral resolution (e.g., number of bands and their wavelengths). The metadata can include calibration data, such as information needed to convert raw data into meaningful physical quantities. The metadata can include environmental conditions, such as solar angles: position of the sun at the time of image capture, including solar azimuth and elevation. The metadata can include weather conditions, such as information about atmospheric conditions, such as cloud cover. The metadata can include image quality, such as noise levels indicating data on the amount of noise present in the image. The metadata can include compression artifacts, such as information on any compression applied to the collected remote sensing images.

At 308, image preprocessing can be applied, by the one or more processors. The image preprocessing can perform rectifications or modifications as required by the input of the detection system. In some implementations, image preprocessing can include applying geometric alignments to the remote sensing images to generate aligned images and applying radiometric corrections to the aligned images to generate radiometric corrected images. The geometric correction correct distortions in the image caused by the sensor's perspective, earth's curvature, and terrain variations. Geometric corrections generate corrected images that accurately represent the earth's surface. Geometric correction include: orthorectification including adjusting the image to remove distortions caused by the sensor's angle and the earth's topography, aligning it with a map coordinate system; and georeferencing including assigning real-world coordinates to the image pixels, often using ground control points to match the image with known locations on the earth's surface. Radiometric correction addresses variations in the image's pixel values caused by atmospheric conditions, sensor noise, and illumination differences. The radiometric correction process facilitate the pixel values to accurately reflect the true radiance or reflectance of the earth's surface. Radiometric correction includes: atmospheric correction including removing the effects of atmospheric scattering and absorption to retrieve the true surface reflectance; sensor calibration including correcting for sensor-specific biases and noise to ensure consistent and accurate measurements across different images and sensors; normalization including adjusting the image to account for differences in illumination and viewing geometry, ensuring that images taken at different times or under different conditions are comparable. The described preprocessing facilitate sand distribution classification, sand movement change detection, and sand movement pattern monitoring, where accurate and consistent data is essential.

At 310, a first artificial intelligence model is used, by the one or more processors, to identify a change in the sand distribution within the area of interest. The first artificial intelligence model receives as input radiometric corrected images and the respective metadata, indicative of the data collection time. In some implementations, the changes in sand distribution within both short time intervals and longtime intervals are determined. The first artificial intelligence model can be a machine learning model configured to identify, detect, classify, and predict changes in sand distribution within the area of interest. The first artificial intelligence model can include any of a neural network (e.g., DNN as described with reference to FIG. 1B), long short-term memory networks (e.g., recurrent neural network), and random forests to identify dune accumulations and sand distribution over time from radiometric corrected images.

At 312, a general sand change map is determined, by the one or more processors. The general sand change map can include a spatial distribution of a sand amount variability index throughout the area of interest. The sand amount variability index can be calculated for each pixel in the radiometric corrected image. The general sand change map can include the points of interest within the area of interest to facilitate an evaluation of the sand distribution over time relative to a distance to the points of interest.

At 314, a second artificial intelligence model is applied to sub-classify the change into the various different formations. The classification of the formations is used to identify and locate specific change detections with patterns attributed to sand movement. The second artificial intelligence model includes a machine learning model that is based on machine learning techniques including neural networks (e.g., DNN) and clustering algorithms. The machine learning techniques can be trained to classify sand movement patterns using labeled sand movement patterns. In some implementations, clustering algorithms for sand movement pattern classification include K-means clustering algorithm partitions data into (k) clusters by minimizing the sum of squared distances between data points and the respective cluster centroids. The K-means clustering algorithm can use as an input a predefined number of clusters. In some implementations, clustering algorithms for sand movement pattern classification include hierarchical clustering that builds a hierarchy of clusters by either merging smaller clusters into larger ones (agglomerative) or splitting larger clusters into smaller ones (divisive), providing information about the data structure at different levels of granularity. In some implementations, clustering algorithms for sand movement pattern classification include density-based clustering (DBSCAN) that groups together points that are closely packed together, marking points that are in low-density regions as outliers. DBSCAN can be particularly effective for datasets with noise and varying densities. In some implementations, clustering algorithms for sand movement pattern classification include spectral clustering that uses the eigenvalues of a similarity matrix to reduce dimensionality before clustering in fewer dimensions. The spectral clustering can be applied to complex data structures that are not well-separated in the original space. In some implementations, clustering algorithms for sand movement pattern classification include density peak clustering (DPC) to identify cluster centers as points with higher local density than their neighbors and are far from each other. The DPC model can be effective for identifying clusters of varying shapes and densities. The clustering algorithms facilitate analysis and classification of sand movement patterns by identifying distinct clusters of movement based on various features such as velocity, direction, and frequency of movement. In some implementations, the first artificial intelligence model and the second artificial intelligence models are combined to perform the change detection and classification as a single processing procedure.

At 316, a sand movement change map is generated, by the one or more processors. The sand movement change map can include a map of sand movement patterns that can include highlights (e.g., frames or circular markers) around identified sand movements, as shown in FIG. 2C. The sand movement change map can include one or more reference points within the image to enable a visualization of the sand movement patterns within the region of interest relative to the reference points. The sand movement pattern map can be transmitted an output reporting system (e.g., output reporting system 112 described with reference to FIGS. 1A and 1B) for display.

At 318, a risk is determined, by the one or more processors. The risk can be determined by performing a temporal variation of materials over the region of interest relative to a distance to a point of interest. For example, changes in the sand accumulation amount in temporally separated images of the same region can be used for change detection, monitoring and object/materials tracking and sand movement patterns. The temporal variation analysis can be applied to scan large regions either domestically or globally for large scale mapping, safety, and security relative to a risk of disrupting operation of equipment due to sand movement patterns.

At 320, an action plan defining an action and a corresponding surface equipment is determined, by the one or more processors. The action plan can be identified by machine learning models (e.g., recurrent neural networks with a multi-layer network topology) trained and fine-tuned to generate an automatic selection of an efficient remedial action (e.g., activation of one or more cleaning machines or deactivation of one or more systems for safety and protection of an environment and an industrial plant). The surface equipment can be selected to match the characteristics of the sand movement pattern and execute the intended sand cleaning or removal operations. The trained machine learning models can be configured to operate in active mode, for sand movement pattern identification, facilitating automatic action plan implementation. For example, the trained machine learning models can trigger an initiation of the action plan, and a modification of surface equipment operations based on most recent maps of sand movement patterns relative to the predicted sand movement patterns and ongoing or expected events.

At 322, the action plan is automatically executed by generating a trigger, by the one or more processors, to activate an operation of a system or a machine configured to perform a remedy operation (e.g., cleaning or sand removal operation). The operation of the system or the machine can include initiation of a transport or (self-) driving operation of the cleaning machinery to the region of interest and activation of a cleaning module of the machine. The cleaning machinery can include (semi-autonomous or fully autonomous) robotic cleaners configured to remove and/or level sand within a region of interest by performing sand removal operations including sweeping, plowing, scraping, raking, or sifting.

The example process 300 facilitates optimization of accurate generation of sand movement pattern map. One of the greatest benefits of generation of an accurate material map is that it facilitates activation of automatic remedial machine actions to ensure continuous workflows and access to facilities. The example process 300 enhances a characterization of regions of interest, providing resource conservation opportunities by minimizing computing system requirements and optimization of monitorization of a large range of materials.

In some implementations, customized user interfaces can present intermediate or final results of the above-described processes on a user interface of a user device. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, material management associated with overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period-of-time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. The described technology can be especially useful for systems or various pieces of equipment that are located several meters or several miles apart or are located in different countries or other jurisdictions.

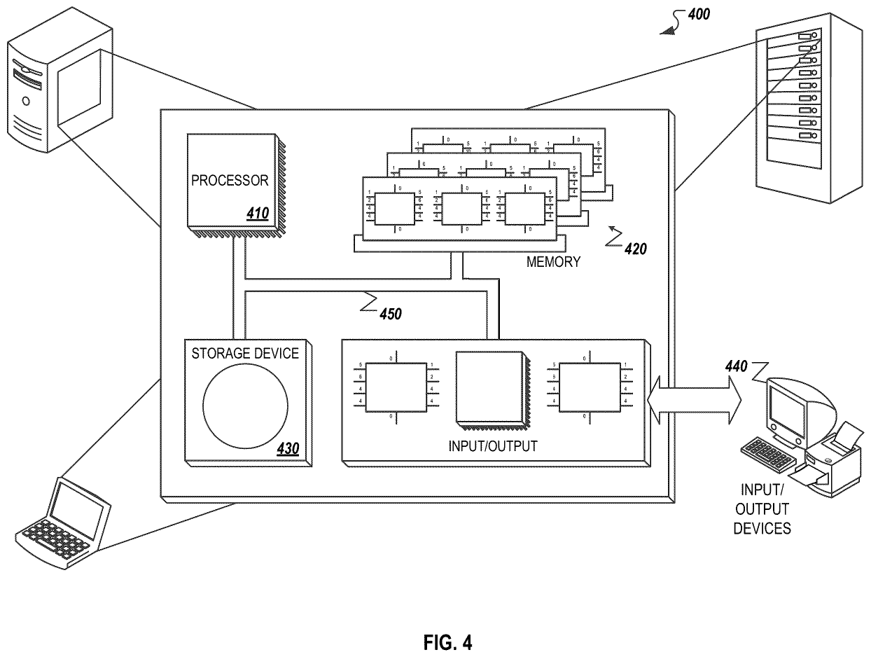

FIG. 4 depicts a block diagram illustrating a computing system 400, in accordance with some example embodiments. Referring to FIGS. 1A and 1B, the computing system 400 can be used to implement the server system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart or are located in different countries or other jurisdictions.

The preceding figures and accompanying description illustrate example processes and computer implementable techniques. The environments and systems described above (or their software or other components) may contemplate using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.
Example 1. A computer-implemented method comprising: receiving data corresponding to a region of interest, the data comprising remote sensing images of the region of interest captured at a plurality of time points and respective metadata; determining by processing the remote sensing images and the respective metadata, using a first artificial intelligence model, a sand distribution change within the region of interest; classifying, using a second artificial intelligence model, the sand distribution change into a plurality of sand movement formations; determining sand movement patterns based on the plurality of sand movement formations; and identifying an action plan to remedy an effect of the sand movement patterns.
Example 2. The computer-implemented method of the preceding example, further comprising:
preprocessing the remote sensing images by applying geometric alignments to the remote sensing images to generate aligned images and applying radiometric corrections to the aligned images to generate corrected images.
Example 3. The computer-implemented method of any of the preceding examples, wherein identifying the action plan comprises determining a risk associated with the sand movement patterns; and generating an alert indicative of the risk associated with the sand movement patterns.
Example 4. The computer-implemented method of any of the preceding examples, wherein the remote sensing images comprise satellite images.
Example 5. The computer-implemented method of any of the preceding examples, wherein the sand movement patterns comprise constant flows, seasonal changes, and wind generated patterns.
Example 6. The computer-implemented method of any of the preceding examples, wherein the effect of the sand movement patterns is determined relative to one or more points of interests.
Example 7. The computer-implemented method of any of the preceding examples, wherein identifying the action plan to remedy the effect of the sand movement patterns comprises activating an equipment to clean or protect the one or more points of interests.
Example 8. A computer-implemented system comprising: memory storing application programming interface (API) information; and a server performing operations comprising: receiving data corresponding to a region of interest, the data comprising remote sensing images of the region of interest captured at a plurality of time points and respective metadata; determining by processing the remote sensing images and the respective metadata, using a first artificial intelligence model, a sand distribution change within the region of interest; classifying, using a second artificial intelligence model, the sand distribution change into a plurality of sand movement formations; determining sand movement patterns based on the plurality of sand movement formations; and identifying an action plan to remedy an effect of the sand movement patterns.
Example 9. The computer-implemented system of the preceding example, wherein the operations further comprise preprocessing the remote sensing images by applying geometric alignments to the remote sensing images to generate aligned images and applying radiometric corrections to the aligned images to generate corrected images.
Example 10. The computer-implemented system of any of the preceding examples, wherein identifying the action plan comprises determining a risk associated with the sand movement patterns; and generating an alert indicative of the risk associated with the sand movement patterns.
Example 11. The computer-implemented system of any of the preceding examples, wherein the remote sensing images comprise satellite images.
Example 12. The computer-implemented system of any of the preceding examples, wherein the sand movement patterns comprise constant flows, seasonal changes, and wind generated patterns.
Example 13. The computer-implemented system of any of the preceding examples, wherein the effect of the sand movement patterns is determined relative to one or more points of interests.
Example 14. The computer-implemented system of any of the preceding examples, wherein identifying the action plan to remedy the effect of the sand movement patterns comprises activating an equipment to clean or protect the one or more points of interests.
Example 15. A non-transitory computer-readable media encoded with a computer program, the computer program comprising instructions that when executed by one or more computers cause the one or more computers to perform operations comprising: receiving data corresponding to a region of interest, the data comprising remote sensing images of the region of interest captured at a plurality of time points and respective metadata; determining by processing the remote sensing images and the respective metadata, using a first artificial intelligence model, a sand distribution change within the region of interest; classifying, using a second artificial intelligence model, the sand distribution change into a plurality of sand movement formations; determining sand movement patterns based on the plurality of sand movement formations; and identifying an action plan to remedy an effect of the sand movement patterns.
Example 16. The non-transitory computer-readable media of the preceding example, wherein the operations further comprise preprocessing the remote sensing images by applying geometric alignments to the remote sensing images to generate aligned images and applying radiometric corrections to the aligned images to generate corrected images.
Example 17. The non-transitory computer-readable media of any of the preceding examples, wherein identifying the action plan comprises determining a risk associated with the sand movement patterns; and generating an alert indicative of the risk associated with the sand movement patterns.
Example 18. The non-transitory computer-readable media of any of the preceding examples, wherein the remote sensing images comprise satellite images.
Example 19. The non-transitory computer-readable media of any of the preceding examples, wherein the sand movement patterns comprise constant flows, seasonal changes, and wind generated patterns.
Example 20. The non-transitory computer-readable media of any of the preceding examples, wherein the effect of the sand movement patterns is determined relative to one or more points of interests, wherein identifying the action plan to remedy the effect of the sand movement patterns comprises activating an equipment to clean or protect the one or more points of interests.

What is claimed is:

1. A computer-implemented method comprising:
receiving data corresponding to a region of interest, the data comprising remote sensing images of the region of interest captured at a plurality of time points and respective metadata;
determining by processing the remote sensing images and the respective metadata, using a first artificial intelligence model, a sand distribution change within the region of interest;
classifying, using a second artificial intelligence model, the sand distribution change into a plurality of sand movement formations;
determining sand movement patterns based on the plurality of sand movement formations; and
identifying an action plan to remedy an effect of the sand movement patterns.

2. The computer-implemented method of claim 1, further comprising:
preprocessing the remote sensing images by applying geometric alignments to the remote sensing images to generate aligned images and applying radiometric corrections to the aligned images to generate corrected images.

3. The computer-implemented method of claim 1, wherein identifying the action plan comprises:
determining a risk associated with the sand movement patterns; and
generating an alert indicative of the risk associated with the sand movement patterns.

4. The computer-implemented method of claim 1, wherein the remote sensing images comprise satellite images.

5. The computer-implemented method of claim 1, wherein the sand movement patterns comprise constant flows, seasonal changes, and wind generated patterns.

6. The computer-implemented method of claim 1, wherein the effect of the sand movement patterns is determined relative to one or more points of interests.

7. The computer-implemented method of claim 6, wherein identifying the action plan to remedy the effect of the sand movement patterns comprises activating an equipment to clean or protect the one or more points of interests.

8. A computer-implemented system comprising:
memory storing application programming interface (API) information; and
a server performing operations comprising:
receiving data corresponding to a region of interest, the data comprising remote sensing images of the region of interest captured at a plurality of time points and respective metadata;
determining by processing the remote sensing images and the respective metadata, using a first artificial intelligence model, a sand distribution change within the region of interest;
classifying, using a second artificial intelligence model, the sand distribution change into a plurality of sand movement formations;
determining sand movement patterns based on the plurality of sand movement formations; and
identifying an action plan to remedy an effect of the sand movement patterns.

9. The computer-implemented system of claim 8, wherein the operations further comprise:
preprocessing the remote sensing images by applying geometric alignments to the remote sensing images to generate aligned images and applying radiometric corrections to the aligned images to generate corrected images.

10. The computer-implemented system of claim 8, wherein identifying the action plan comprises:
determining a risk associated with the sand movement patterns; and
generating an alert indicative of the risk associated with the sand movement patterns.

11. The computer-implemented system of claim 8, wherein the remote sensing images comprise satellite images.

12. The computer-implemented system of claim 8, wherein the sand movement patterns comprise constant flows, seasonal changes, and wind generated patterns.

13. The computer-implemented system of claim 8, wherein the effect of the sand movement patterns is determined relative to one or more points of interests.

14. The computer-implemented system of claim 13, wherein identifying the action plan to remedy the effect of the sand movement patterns comprises activating an equipment to clean or protect the one or more points of interests.

15. A non-transitory computer-readable media encoded with a computer program, the computer program comprising instructions that when executed by one or more computers cause the one or more computers to perform operations comprising:
receiving data corresponding to a region of interest, the data comprising remote sensing images of the region of interest captured at a plurality of time points and respective metadata;
determining by processing the remote sensing images and the respective metadata, using a first artificial intelligence model, a sand distribution change within the region of interest;
classifying, using a second artificial intelligence model, the sand distribution change into a plurality of sand movement formations;
determining sand movement patterns based on the plurality of sand movement formations; and
identifying an action plan to remedy an effect of the sand movement patterns.

16. The non-transitory computer-readable media of claim 15, wherein the operations further comprise:
preprocessing the remote sensing images by applying geometric alignments to the remote sensing images to generate aligned images and applying radiometric corrections to the aligned images to generate corrected images.

17. The non-transitory computer-readable media of claim 15, wherein identifying the action plan comprises:
determining a risk associated with the sand movement patterns; and
generating an alert indicative of the risk associated with the sand movement patterns.

18. The non-transitory computer-readable media of claim 15, wherein the remote sensing images comprise satellite images.

19. The non-transitory computer-readable media of claim 15, wherein the sand movement patterns comprise constant flows, seasonal changes, and wind generated patterns.

20. The non-transitory computer-readable media of claim 15, wherein the effect of the sand movement patterns is determined relative to one or more points of interests, wherein identifying the action plan to remedy the effect of the sand movement patterns comprises activating an equipment to clean or protect the one or more points of interests.
